(19) United States
(12) Patent Application Publication
(10) Pub. No.: US 2023/0396357 A1
(43) Pub. Date: Dec. 7, 2023

(54) INDICATION OF NETWORK CONDITION AT A REMOTE UE

(71) Applicant: QUALCOMM Incorporated, San Diego, CA (US)

(72) Inventors: Arun Ashok TAGARE, Hyderabad (IN); Bapineedu Chowdary GUMMADI, Hyderabad (IN); Shankar Ganesh LAKSHMANASWAMY, Bangalore (IN); Ravi Shankar KADAMBALA, Hyderabad (IN)

(21) Appl. No.: 17/804,896

(22) Filed: Jun. 1, 2022

(51) Int. Cl. H04L 1/00; H04W 24/10; H04W 72/04; H04W 72/12; H04W 72/14

(52) U.S. Cl. CPC H04L 1/0026; H04W 24/10; H04W 72/14; H04W 72/1278; H04W 72/0406

(57) ABSTRACT

This disclosure provides systems, devices, apparatus, and methods, including computer programs encoded on storage media, for indicating, at a local UE, a network condition at a remote UE. The local UE may be a first UE that receives, from a second UE (e.g., remote UE), a first indication of a decreased network condition at the second UE. The first indication may be associated with at least one of a TMMBr, a TMMBn, a decreased bit rate, or decreased downlink scheduling. The first UE may display, at the first UE, a second indication of the decreased network condition at the second UE based on the first indication received from the second UE.

### TECHNICAL FIELD

The present disclosure relates generally to communication systems, and more particularly to indicating, at a local user equipment (UE), a network condition at a remote UE.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a first user equipment (UE) configured to receive, from a second UE, a first indication of a decreased network condition at the second UE, the first indication associated with at least one of a temporary maximum media stream bit rate request (TMMBr), a temporary maximum media stream bit rate notification (TMMBn), a decreased bit rate, or decreased downlink scheduling; and display, at the first UE, a second indication of the decreased network condition at the second UE based on the first indication received from the second UE.

In another aspect of the disclosure, a method, a computer-readable medium, and an apparatus are provided. The apparatus may be a second UE configured to receive a local indication of a decreased network condition at the second UE; and transmit, to a first UE, an indication of the decreased network condition at the second UE, the indication associated with at least one of a TMMBr, a TMMBn, a decreased bit rate, or decreased downlink scheduling.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a first user equipment (UE) in communication with a second UE.

FIG. 4 is a call flow diagram illustrating communications between a first UE and a second UE.

FIG. 5 is a diagram that illustrates bits of an extension header and/or in-band signaling.

FIG. 6 is a flowchart of a method of wireless communication at a first UE.

FIG. 7 is a flowchart of a method of wireless communication at a first UE.

FIG. 8 is a flowchart of a method of wireless communication at a second UE.

FIG. 9 is a flowchart of a method of wireless communication at a second UE.

FIG. 10 is a diagram illustrating an example of a hardware implementation for an example apparatus and/or network entity.

### DETAILED DESCRIPTION

Communications between a first user equipment (UE) and a second UE, such as video calls or voice calls, may degrade during the course of a call based on decreased network conditions at the first UE and/or the second UE. For example, a video call may become blurry, experience a lag in a video data stream, etc. A user of the first UE (e.g., local UE) may suspect that the decreased network conditions are at the local UE, even when the decreased network condition are actually at the second UE 404 (e.g., remote UE) with which the first UE 402 is communicating. Thus, the user of the first UE may unnecessarily reset/reboot the first UE and/or close/reset applications that are executing at the first UE in an attempt to improve the network conditions that the user suspects to be decreased at the first UE. Aspects presented herein provide for the first UE/local UE to determine which UE is experiencing the decreased network conditions and indicate the determination to the user of the first UE via a user interface (UI) of the first UE. The second UE/remote UE may also display an indication to the user of the second UE via a UI of the second UE indicative of which UE is experiencing the decreased network conditions. The aspects presented herein may help the users of the first UE and/or the second UE to avoid making unneeded adjustments when the network conditions at the other UE are causing the lower performance.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

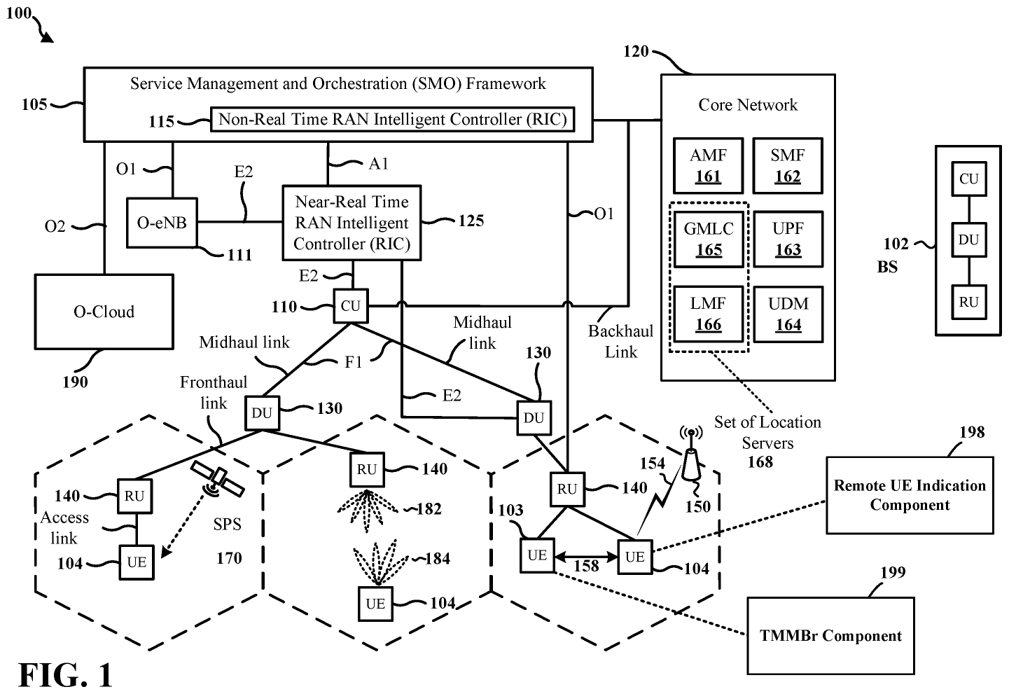

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective user equipments (UEs) 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some

deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on

frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz).

Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a remote UE indication component 198 configured to receive, from a second UE, a first indication of a decreased network condition at the second UE, the first indication associated with at least one of a temporary maximum media stream bit rate request (TMMBr), a temporary maximum media stream bit rate notification (TMMBn), a decreased bit rate, or decreased downlink scheduling; and display, at the first UE, a second indication of the decreased network condition at the second UE based on the first indication received from the second UE. In certain aspects, a remote UE 103 may include a TMMBr component 199 configured to receive a local indication of a decreased network condition at the second UE; and transmit, to a first UE, an indication of the decreased network condition at the second UE, the indication associated with at least one of a TMMBr, a TMMBn, a decreased bit rate, or decreased downlink scheduling. Although the following description may be focused on 5G NR, the concepts described herein may be applicable to other similar areas, such as LTE, LTE-A, CDMA, GSM, and other wireless technologies.

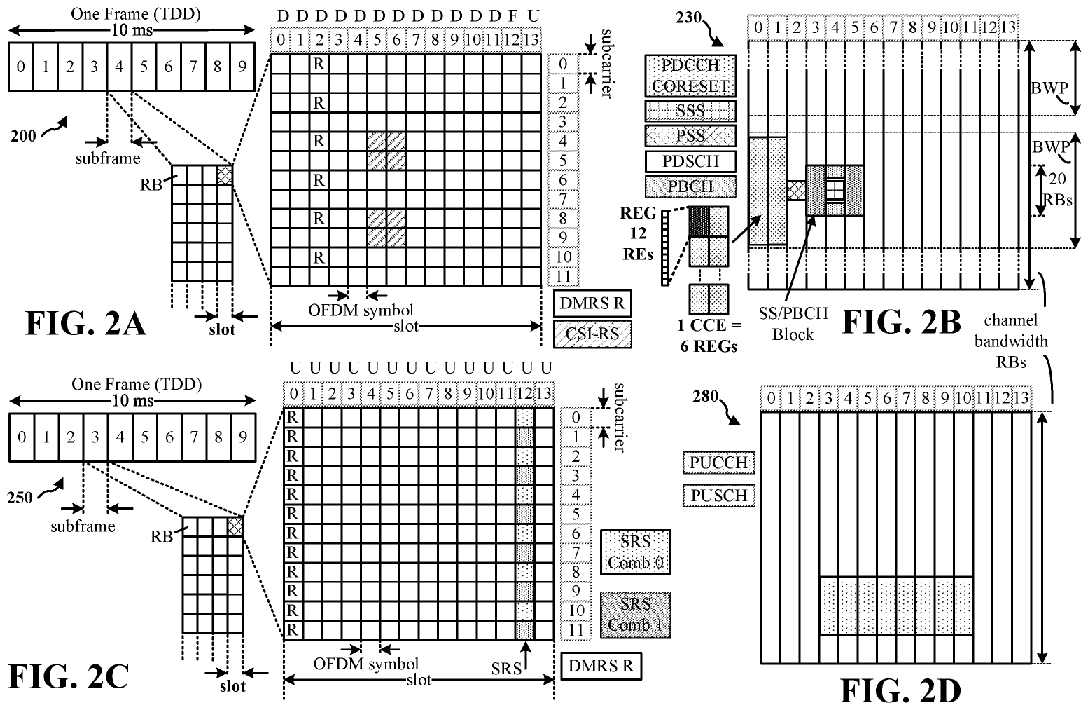

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure

may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | Cyclic |
|---|---|---|
| μ | Δf = 2^{μ} · 15 [kHz] | prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a

frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIB s), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

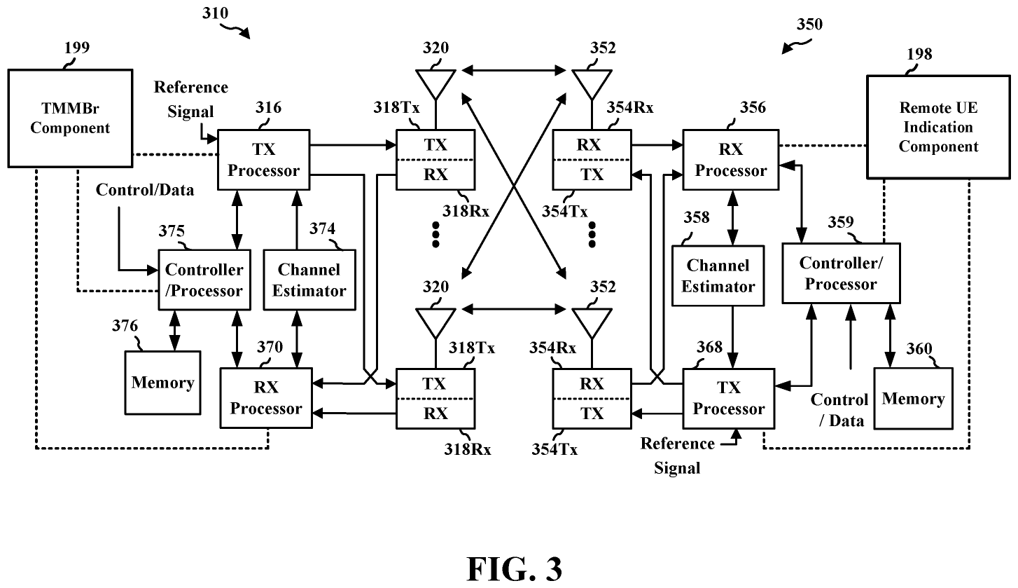

FIG. 3 is a block diagram of a second UE 310 in communication with a first UE 350 in an access network. In the DL, Internet protocol (IP) packets may be provided to a controller/processor 375. The controller/processor 375 implements layer 3and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the first UE 350. Each spatial stream may then be provided to a different antenna 320 via a separate transmitter 318Tx. Each transmitter 318Tx may modulate a radio frequency (RF) carrier with a respective spatial stream for transmission.

At the first UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the first UE 350. If multiple spatial streams are destined for the first UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the second UE 310. These soft decisions may be based on channel estimates computed by the channel estimator 358. The soft decisions are then decoded and deinterleaved to recover the data and control signals that were originally transmitted by the second UE 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the second UE 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the second UE 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the second UE 310 in a manner similar to that described in connection with the receiver function at the first UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the remote UE indication component 198 of FIG. 1.

At least one of the TX processor 316, the RX processor 370, and the controller/processor 375 may be configured to perform aspects in connection with the TMMBr component 199 of FIG. 1.

Wireless communication systems may be configured to share available system resources and provide various telecommunication services (e.g., telephony, video, data, messaging, broadcasts, etc.) based on multiple-access technologies such as CDMA systems, TDMA systems, FDMA systems, OFDMA systems, SC-FDMA systems, TD-SCDMA systems, etc. that support communication with multiple users. In many cases, common protocols that facilitate communications with wireless devices are adopted in various telecommunication standards. For example, communication methods associated with eMBB, mMTC, and ultra-reliable low latency communication (URLLC) may be incorporated in the 5G NR telecommunication standard, while other aspects may be incorporated in the 4G LTE standard. As mobile broadband technologies are part of a continuous evolution, further improvements in mobile broadband remain useful to continue the progression of such technologies.

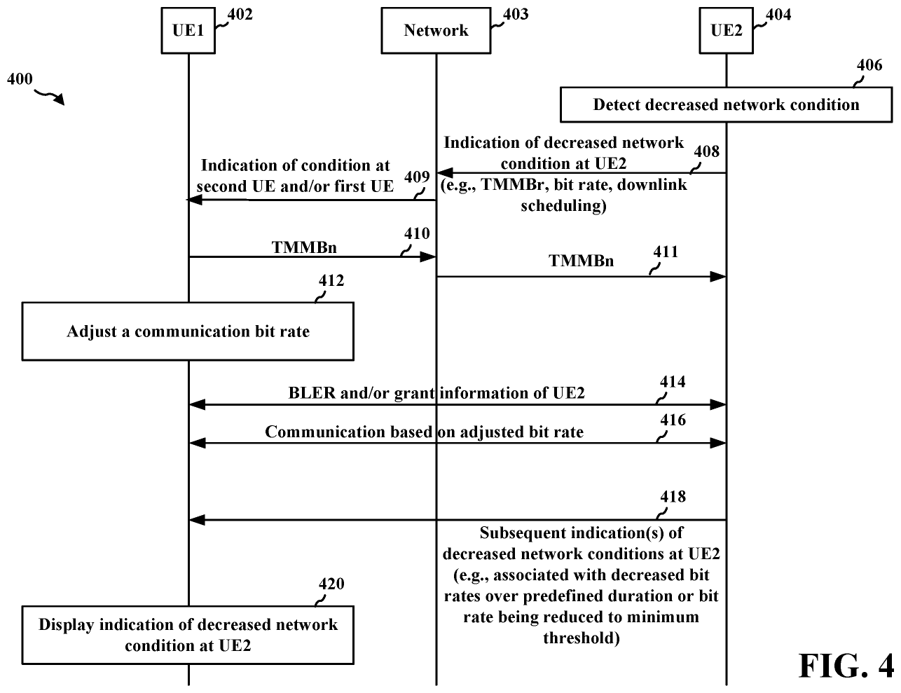

FIG. 4 is a call flow diagram 400 illustrating communications between a first UE 402, a second UE 404, and a network 403. The first UE 402 may be a local UE and the second UE 404 may be a remote UE in communication with the local UE. Communications between the first UE 402 and the second UE 404, such as video calls or voice calls, may degrade during the course of a call based on decreased network conditions at the first UE 402 and/or the second UE 404. For example, a video call may become blurry, experience a lag in a video data stream, etc. A decreased quality of experience (QoE) for the user of the first UE 402 (e.g., local UE) may cause the user to suspect that the decreased network conditions are at the first UE 402 (e.g., local UE), even though the decreased network condition may actually be at the second UE 404 (e.g., remote UE) with which the first UE 402 is communicating.

Decreased network conditions that are suspected by the user to be at the first UE 402 may cause the user of the first UE 402 to reset/reboot the first UE 402 in an attempt to improve the network conditions that the user suspects to be decreased at the first UE 402. In other examples, the user may close/reset applications that are executing at the first UE 402 based on the decreased network conditions suspected to be at the first UE 402. However, if the decreased network conditions are actually at the second UE 404, resetting/rebooting the first UE 402 or closing/resetting applications of the first UE 402 may not cause the QoE of the user of the first UE 402 to be improved. Further, power consumption at the first UE 402 may be increased, as restarting an application and/or the device may consume an increased amount of power in comparison to allowing the application and/or the device to continue executing.

With no indication to the user of the first UE 402 as to which end of the communication link between the first UE 402 and the second UE 404 is experiencing the decreased network conditions, the user may attempt to reset/reboot the first UE 402 or close/reset applications of the first UE 402 even if the user understands that the decreased network conditions could potentially be at the second UE 404. However, because the user may have no way to determine which UE is associated with the decreased network conditions, the user may unnecessarily perform such procedures in an attempt to troubleshoot the decreased QoE.

At 406, the second UE 404 may detect decreased network conditions at the second UE 404, such that an indication may be provided to the user of the first UE 402, based on the detection at 406, regarding which UE is associated with the decreased network conditions. FIG. 4 illustrates that the second UE 404 may provide an indication of a decreased network condition to the network at 408. The network may then provide an indication 409 to the first UE. In some aspects, the indication 409 may include the information provided at 408. In other aspects, the indication 409 may instead indicate that a condition for the first UE 402 is good, which may protect privacy of information for the second UE 404. The indication may allow the user of the first UE 402 to more accurately identify the cause of the degraded QoE. Accordingly, the first UE 402 may be configured to indicate/display, at 420, via a user interface (UI) of the first UE 402 whether the decreased network conditions are associated with the first UE 402 or the second UE 404. The second UE/remote UE may also display an indication to the user of the second UE via a UI of the second UE indicative of which UE is experiencing the decreased network conditions. In examples, the indication displayed, at 420, via the UI of the first UE 402 may further indicate a reason for the degraded QoE. Such indications may be displayed, at 420, via the UI of the first UE 402 for both audio calls and video calls. In further examples, the indication may be displayed at a UI of the second UE 404, such that a second user of the second UE 404 may similarly determine a cause of the degraded QoE at the second UE 404.

In cases of video calls, a codec and a maximum bit rate may be negotiated between the first UE 402 and the second UE 404. “Codec” refers to software or hardware that compresses and decompresses digital video data. In the context of video compression/decompression, codec is a portmanteau that blends the sounds and meanings of “encoder” and “decoder.” While a device that only compresses may be referred to as an “encoder” and a device that only decompresses may be referred to as a “decoder”, a codec may perform both functionalities. The codec and the max bit rate for the video call may be based on a session description protocol (SDP) negotiation associated with handshaking between the first UE 402 and the second UE 404.

At 408, the second UE 404 may transmit to the network 403 and/or to the first UE 402, e.g., via the network 403, an indication of the decreased network conditions at the second UE 404 for the user of the first UE 402 to confirm which end of the communication link between the first UE 402 and the second UE 404 is experiencing the decreased network conditions. Video calls may be associated with a temporary maximum media stream bit rate request (TMMBr) and/or a temporary maximum media stream bit rate notification (TMMBn). If either the first UE 402 or the second UE 404 experiences decreased network conditions, decreased channel conditions, network congestion, or the like, that cause the QoE associated with one or both of the UEs to be decreased, the UE that is associated with the decreased QoE may transmit a TMMBr to the other UE to request that the bit rate be adjusted (e.g., increased or decreased). In cases where the first UE 402 and the second UE 404 do not perform a negotiation, such as in non-IP multimedia subsystem (IMS) examples, decreased network conditions at the second UE 404 may be indicated, at 408, to the first UE 402 based on a reduced amount of downlink scheduling for the second UE 404.

In an example, if the first UE 402 and the second UE 404 are communicating via a video call and the network conditions at the second UE 404 decrease, the second UE 404 may transmit the TMMBr to the first UE 402 via the network 403, so that the first UE 402 may adjust the bit rate (e.g., sending/Tx bit rate to the second UE 404). A decreased bit rate received by the second UE 404 associated with the decreased network conditions at the second UE 404 may prevent the video call from being downgraded to an audio call. Hence, the TMMBr may be similar to a feedback mechanism to the first UE 402 indicative of a video quality at the second UE 404. The TMMBr may indicate to the first UE 402 whether to increase/decrease the Tx/sending bit rate to the second UE 404.

The first UE 402 may indicate/display, at 420, via the UI of the first UE 402 that the decreased network conditions are associated with the second UE 404 based on receiving, at 408, the TMMBr from the second UE 404. For example, the indication displayed, at 420, via the UI of the first UE 402 may explicitly indicate to the user of the first UE 402 that network conditions are decreased at the remote end of the communication link between the first UE 402 and the second UE 404. In examples associated with privacy implications at the second UE 404, the first UE 402 may indicate/display, at 420, via the UI of the first UE 402 that network conditions at the first UE 402/local end of the communication link between the first UE 402 and the second UE 404 are at a sufficient level (e.g., not decreased). Based on such indications, the user of the first UE 402 may not suspect that local conditions at the first UE 402 are decreased during video/audio calls with the second UE 404.

If the TMMBr is not received, at 408, from the second UE 404 but the bit rate associated with the communication between the first UE 402 and the second UE 404 is reducing, the first UE 402 may indicate/notify the user of the first UE 402 via the UI of the first UE 402 that network conditions for the session are decreased. That is, if the first UE 402 repeatedly receives requests for, or reductions in, the bit rate, the first UE 402 may determine that the network conditions for the session are decreased and may indicate the decreased session conditions via the UI of the first UE 402. The second UE 404 may transmit, at 408, the TMMBr to the first UE 402 during the video call based on detected conditions, at 406, at the second UE 404, such as network congestion, packet loss, jitter, etc. The first UE 402 may correspond to a media sender that may act upon the request received, at 408, from the second UE 404 to reduce a sending media bit rate.

The first UE 402 may transmit, at 410, a response to the second UE 404 via the network 403 after receiving, at 408, the TMMBr from the second UE 404. The response may be transmitted, at 410, to the second UE 404 via a TMMBn. For example, after the first UE 402 receives, at 408, the TMMBr from the second UE 404, the first UE 402 may transmit, at 410, a TMMBn that may serve as an ACK to the second UE 404, which may be received by the second UE at 411. For example, after the second UE 404 detects bad/good network conditions at the second UE 404 and transmits, at 408, the TMMBr to the first UE 402 to reduce/increase the sending bitrate, the first UE may transmit, at 410, the TMMBn to the second UE 404 to acknowledge the TMMBr received from the second UE 404. The first UE 402 may also reconfigure the encoding bit rate of the codec/encoder/decoder. For example, at 412, the first UE 402 may adjust a communication bit rate with the second UE based on the indication received, at 408, of the decreased network conditions at the second UE 404 and/or the TMMBn transmitted, at 410. At 414, the first UE 402 may request and/or receive block error rate (BLER) information or grant information associated with uplink/downlink communications of the second UE 404. After adjusting, at 412, the communication bit rate and/or receiving, at 414, the BLER/grant information, the first UE 402 may transmit, at 416, a communication to the second UE 404 based on the adjustment (e.g., increase/decrease) to the bit rate.

Some procedures of the first UE 402 may be based on more than one TMMBr. For example, the first UE 402 may receive, e.g., via the network at 418, one or more subsequent indications of the decreased network conditions at the second UE 404. The one or more subsequent indications received, at 418, may correspond to one or more TMMBr received over a predefined duration for decreasing the sending bit rate during a video call, based on the second UE 404 being unable to recover from the decreased network conditions detected, at 406, over the predefined time duration. The first UE 402 may perform multiple 50% reductions of the bit rate (e.g., beginning from a maximum bit rate negotiated for the session). If the bit rate is reduced to a minimum bit rate/threshold, the first UE 402 may indicate/display, at 420, to the user of the first UE 402 via the UI of the first UE 402 that network conditions are decreased at the second UE 404/remote end of the communication link between the first UE 402 and the second UE 404. The first UE 402 may also downgrade the video call to an audio call based on the minimum bit rate/threshold being reached. The indication/notification displayed, at 420, via the UI of the first UE 402 may allow the user of the first UE 402 to determine which end of the communication link is causing the downgrade to the audio call.

A reason for the video call being of decreased quality may correspond to decreased channel conditions and/or congestion at the remote end of the communication link between the first UE 402 and the second UE 404. The user of the first UE 402 may or may not be notified of the reason for which the decreased quality was caused at the remote end of the communication link. For instance, the user of the first UE 402 may simply be notified via the UI of the first UE 402 that decreased network conditions exist at the second UE 404 without further indication/explanation.

The indication/notification displayed, at 420, via the UI of the first UE 402 may also be performed for audio calls, or other calls for which real-time transport protocol (RTP) feedback is not used, based on in-band procedures. The indication/notification displayed, at 420, via the UI of the first UE 402 may also be applicable to video calls where TMMBr and TMMBn procedures are not negotiated between the first UE 402 and the second UE 404 during call origination. An RTP extension header (e.g., with a 2-bit granularity) included in a one-byte RTP packet may be used to transmit the indication, at 408, of the decreased network conditions in-band. When the first UE 402 receives the RTP packet, the first UE 402 may determine that the second UE 404 (e.g., sender UE) is experiencing decreased network conditions, and may reduce the sending bit rate to the second UE 404. The extension header may be based on the SDP negotiations associated with the handshaking between the first UE 402 and the second UE 404. In an example, if the first UE 402 and the second UE 404 are communicating based on an audio call or video call, and the second UE 404 is experiencing decreased network condition or has reduced downlink scheduling, the second UE 404 may transmit a 1 byte RTP packet to the first UE 402 to indicate that the network conditions at the second UE 404 are decreased.

The first UE 402 may indicate/display, at 420, to the user of the first UE 402 via the UI of the first UE 402 that the network conditions at the second UE 404 are decreased. Indications based on extension headers of the RTP may be transmitted in-band to reduce extra signaling between the first UE 402 and the second UE 404. Thus, the indication from the second UE 404 to the first UE 402 may be based on in-band signaling or an in-band RTP extension header.

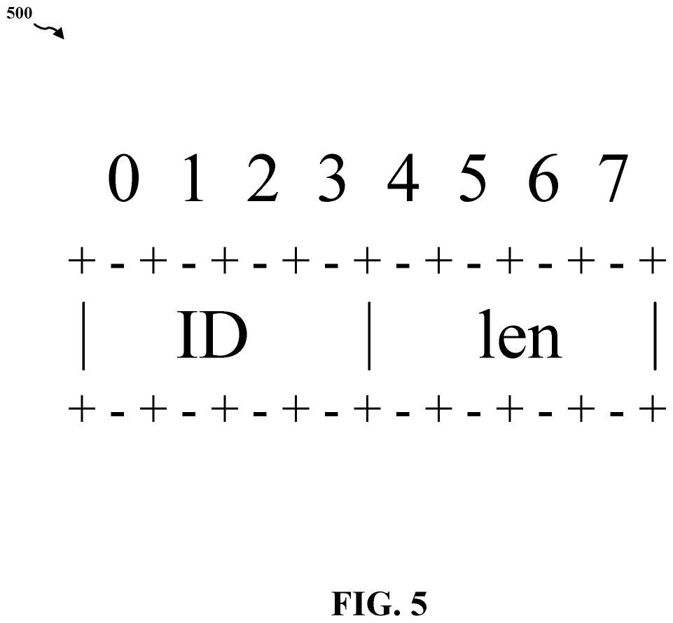

FIG. 5 is a diagram 500 that illustrates bits of an extension header and/or in-band signaling. The extension header and/or in-band signaling may be indicative of an extension identifier (ID), channel conditions, uplink/downlink grants, a measurement value of a reference signal received power (RSRP), a measurement value of a reference signal received quality (RSRQ), a measurement value of a received signal strength indicator (RS SI), and/or a signal-to-interference-plus-noise ratio (SINR). The diagram 500 may correspond to a 1-byte extension header based on a format of an RTP packet.

The 1-byte extension header may include an initial 4 bits reserved for an ID of the RTP packet and a remaining 4 bits of length (len) for other parameters. That is, bits 0-3 may be indicative of the extension ID and bits 4-7 may be indicative of the channel condition, uplink/downlink grant information, RSRP/RSRQ/RS SI measurements, a SINR, etc. In some examples, the extension header may be extended to 2 bytes to accommodate more network condition information. Based on the bit information/RTP packet, the first UE may indicate/display via the UI of the first UE the conditions at the second UE/remote end of the communication link between the first UE and the second UE. A reason for decreased network conditions at the second UE may also be indicated/displayed via the UI of the first UE. Extension header and/or in-band signaling techniques may be performed for audio calls and other cases where video feedback mechanisms are not implemented.

The SDP or an RTP extension mapping may be negotiated during video call setup. The RTP extension packet may be transmitted based on predefined network conditions occurring at the second UE. Accordingly, either a TMMBr or an RTP packet may be transmitted from the second UE to the first UE, which may be indicative of the network conditions at the second UE. The first UE may indicate/display, via the UI of the first UE, the network conditions at the remote end of the communication link between the first UE and the second UE based on the TMMBr or the RTP packet, such that the user of the first UE may determine which end of the communication link may be associated with the decreased network conditions.

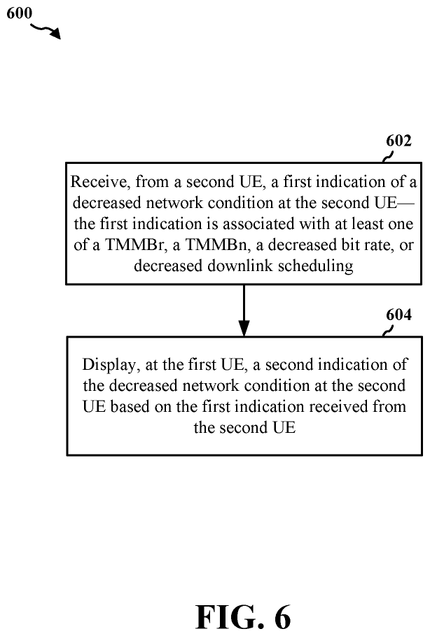

FIG. 6 is a flowchart 600 of a method of wireless communication. The method may be performed by a first UE (e.g., the UE 104, 350, 402, the apparatus 1004, etc.), which may include the memory 360 and which may correspond to the entire UE 104, 350, 402 or apparatus 1004, or a component of the UE 104, 350, 402 or the apparatus 1004, such as the TX processor 368, the RX processor 356, the controller/processor 359, the cellular baseband processor 1024, and/or the application processor 1006.

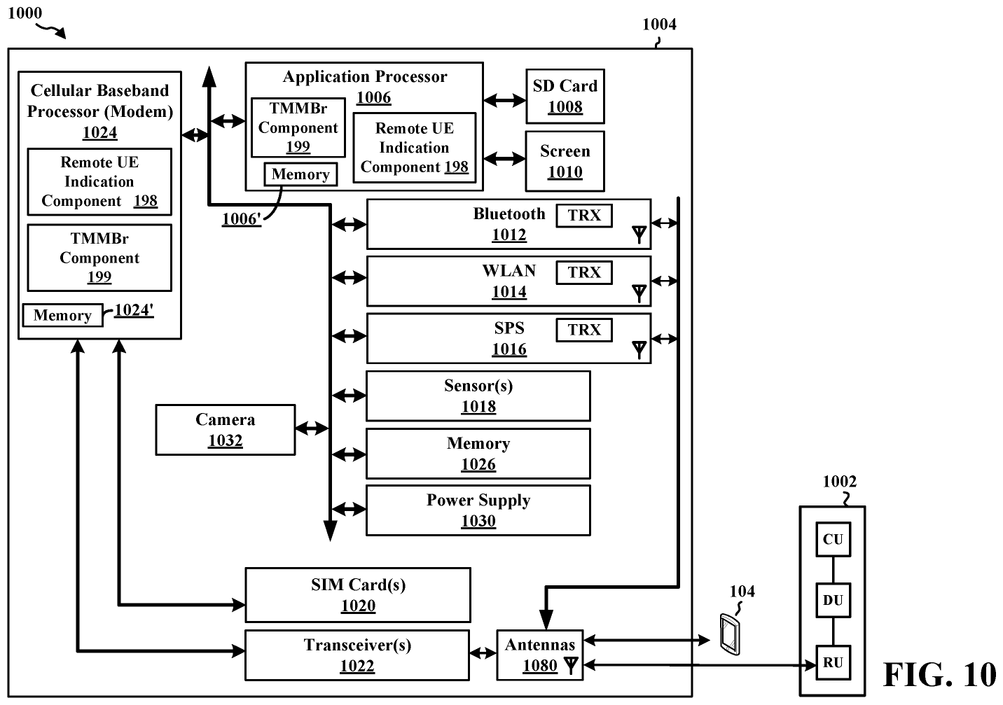

At 602, the first UE may receive, from a second UE, a first indication of a decreased network condition at the second UE—the first indication is associated with at least one of a TMMBr, a TMMBn, a decreased bit rate, or decreased downlink scheduling. For example, referring to FIG. 4, the first UE 402 may receive, at 408, from the second UE 404 an indication of a decreased network condition at the second UE 404. The indication received, at 408, from the second UE 404 may be a TMMBr and/or indicative of a communication bit rate or downlink scheduling associated with the second UE 404. The reception, at 602, may be performed based on the remote UE indication component 198 of the apparatus 1004 in FIG. 10.

At 604, the first UE may display, at the first UE, a second indication of the decreased network condition at the second UE based on the first indication received from the second UE. For example, referring to FIG. 4, the first UE 402 may display, at 420, an indication of the decreased network condition at the second UE 404 based on the indication received, at 408, from the second UE 404 of the decreased network condition at the second UE 404. The displaying, at 604, may be performed based on the remote UE indication component 198 of the apparatus 1004 in FIG. 10.

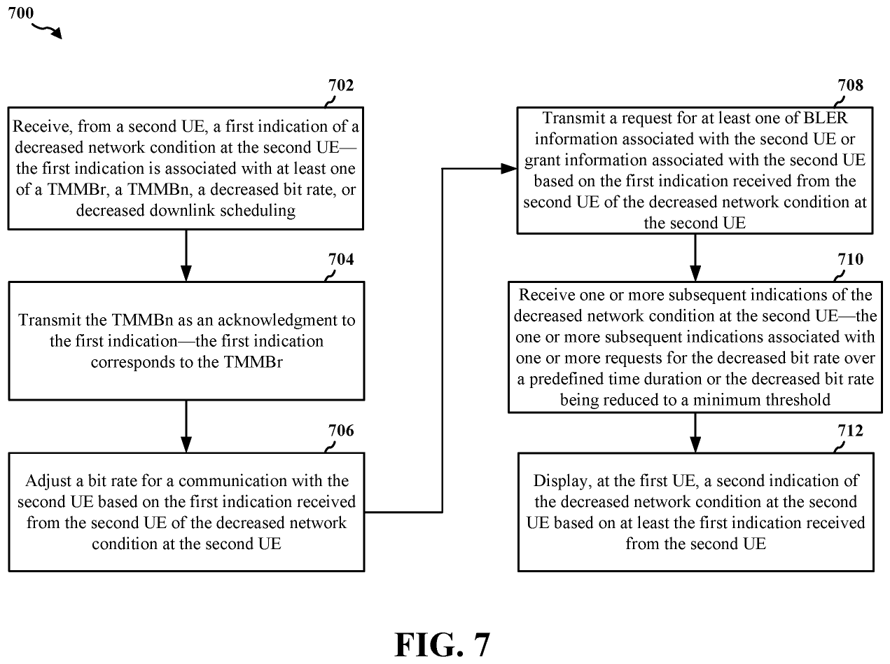

FIG. 7 is a flowchart 700 of a method of wireless communication. The method may be performed by a first UE (e.g., the UE 104, 350, 402, the apparatus 1004, etc.), which may include the memory 360 and which may correspond to the entire UE 104, 350, 402 or apparatus 1004, or a component of the UE 104, 350, 402 or the apparatus 1004, such as the TX processor 368, the RX processor 356, the controller/processor 359, the cellular baseband processor 1024, and/or the application processor 1006.

At 702, the first UE may receive, from a second UE, a first indication of a decreased network condition at the second UE-the first indication is associated with at least one of a TMMBr, a TMMBn, a decreased bit rate, or decreased downlink scheduling. For example, referring to FIG. 4, the first UE 402 may receive, at 408, from the second UE 404 an indication of a decreased network condition at the second UE 404. The indication received, at 408, from the second UE 404 may be a TMMBr and/or indicative of a communication bit rate or downlink scheduling associated with the second UE 404. The reception, at 702, may be performed based on the remote UE indication component 198 of the apparatus 1004 in FIG. 10.

At 704, the first UE may transmit the TMMBn as an acknowledgment to the first indication based on the TMMBn—the first indication corresponds to the TMMBr. For example, referring to FIG. 4, the first UE 402 may transmit, at 410, the TMMBn to the second UE 404. The TMMBn transmitted, at 410, to the second UE 404 may be responsive to the indication received, at 408, from the second UE 404 of the decreased network condition at the second UE 404. The transmission, at 704, may be performed based on the remote UE indication component 198 of the apparatus 1004 in FIG. 10.

At 706, the first UE may adjust a bit rate for a communication with the second UE based on the first indication received from the second UE of the decreased network condition at the second UE. For example, referring to FIG. 4, the first UE 402 may adjust, at 412, a communication bit rate with the second UE 404 based on the indication received, at 408, from the second UE 404 of the decreased network condition at the second UE 404. The adjustment, at 706, may be performed based on the remote UE indication component 198 of the apparatus 1004 in FIG. 10.

At 708, the first UE may transmit a request for at least one of BLER information associated with the second UE or grant information associated with the second UE based on the first indication received from the second UE of the decreased network condition at the second UE. For example, referring to FIG. 4, the first UE 402 may transmit a request/receive a response, at 414, for BLER and/or grant information associated with the second UE 404. The first UE 402 may transmit the request/receive the response, at 414, for the BLER and/or the grant information based on the indication received, at 408, from the second UE 404 of the decreased network condition at the second UE 404. The transmission, at 708, may be performed based on the remote UE indication component 198 of the apparatus 1004 in FIG. 10.

At 710, the first UE may receive one or more subsequent indications of the decreased network condition at the second UE-the one or more subsequent indications associated with one or more requests for the decreased bit rate over a predefined time duration or the decreased bit rate being reduced to a minimum threshold. For example, referring to FIG. 4, the first UE 402 may receive, at 418, from the second UE 404 one or more subsequent indications of the decreased network conditions at the second UE 404. The one or more subsequent indications received, at 418, from the second UE 404 may be associated with decreased bit rates over a predefined time duration or the bit rate being reduced to a minimum threshold. The reception, at 710, may be performed based on the remote UE indication component 198 of the apparatus 1004 in FIG. 10.

At 712, the first UE may display, at the first UE, a second indication of the decreased network condition at the second UE based on at least the first indication received from the second UE. For example, referring to FIG. 4, the first UE 402 may display, at 420, an indication of the decreased network condition at the second UE 404 based on the indication received, at 408, from the second UE 404 of the decreased network condition at the second UE 404. The displaying, at 712, may be performed based on the remote UE indication component 198 of the apparatus 1004 in FIG. 10.

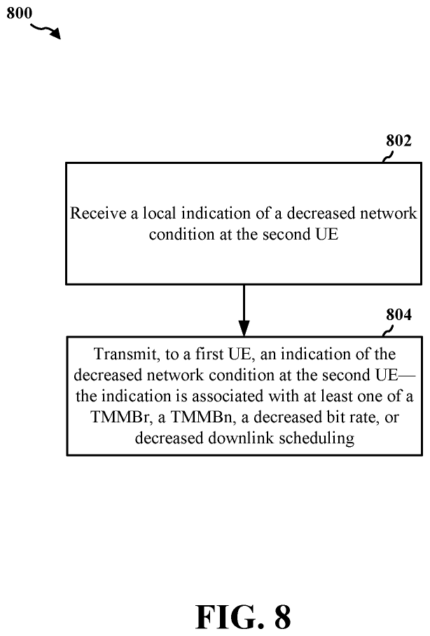

FIG. 8 is a flowchart 800 of a method of wireless communication. The method may be performed by a second UE (e.g., the UE 103, 310, 404, the apparatus 1004, etc.), which may include the memory 376 and which may correspond to the entire UE 103, 310, 404 or apparatus 1004, or a component of the UE 103, 310, 404 or the apparatus 1004, such as the TX processor 316, the RX processor 370, the controller/processor 375, the cellular baseband processor 1024, and/or the application processor 1006.

At 802, the second UE may receive a local indication of a decreased network condition at the second UE. For example, referring to FIG. 4, the second UE 404 may detect, at 406, a decreased network condition at the second UE 404. The reception, at 802, may be performed based on the TMMBr component 199 of the apparatus 1004 in FIG. 10.

At 804, the second UE may transmit, to a first UE, an indication of the decreased network condition at the second UE—the indication is associated with at least one of a TMMBr, a TMMBn, a decreased bit rate, or decreased downlink scheduling. For example, referring to FIG. 4, the second UE 404 may transmit, at 408, to the first UE 402 an indication of a decreased network condition at the second UE 404. The indication transmitted, at 408, to the first UE 402 may be a TMMBr and/or indicative of a communication bit rate or downlink scheduling associated with the second UE 404. The transmission, at 804, may be performed based on the TMMBr component 199 of the apparatus 1004 in FIG. 10.

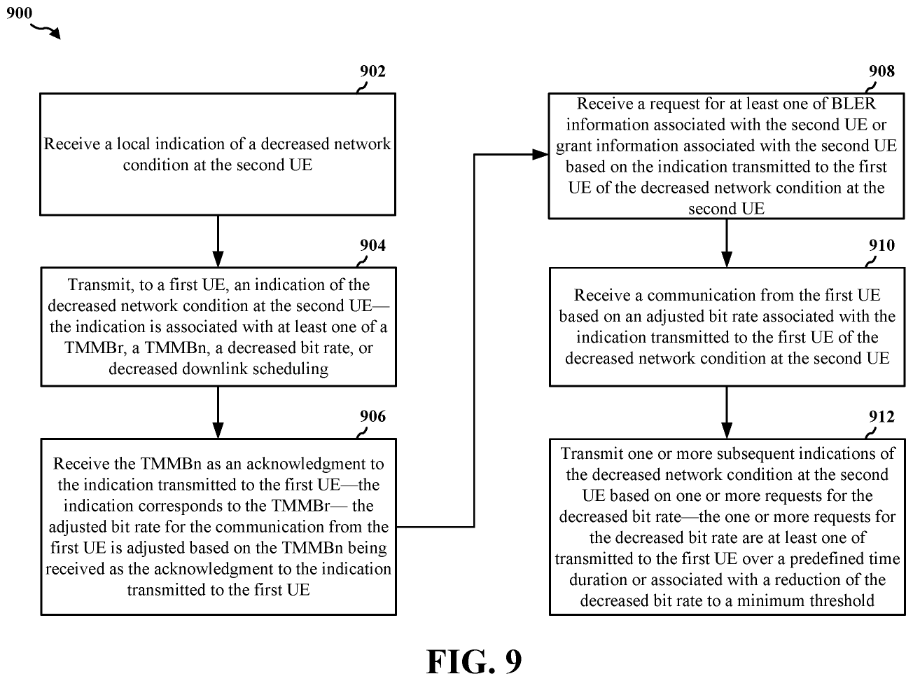

FIG. 9 is a flowchart 900 of a method of wireless communication. The method may be performed by a second UE (e.g., the UE 103, 310, 404, the apparatus 1004, etc.), which may include the memory 376 and which may correspond to the entire UE 103, 310, 404 or apparatus 1004, or a component of the UE 103, 310, 404 or the apparatus 1004, such as the TX processor 316, the RX processor 370, the controller/processor 375, the cellular baseband processor 1024, and/or the application processor 1006.

At 902, the second UE may receive a local indication of a decreased network condition at the second UE. For example, referring to FIG. 4, the second UE 404 may detect, at 406, a decreased network condition at the second UE 404. The reception, at 902, may be performed based on the TMMBr component 199 of the apparatus 1004 in FIG. 10.

At 904, the second UE may transmit, to a first UE, an indication of the decreased network condition at the second UE—the indication is associated with at least one of a TMMBr, a TMMBn, a decreased bit rate, or decreased downlink scheduling. For example, referring to FIG. 4, the second UE 404 may transmit, at 408, to the first UE 402 an indication of a decreased network condition at the second UE 404. The indication transmitted, at 408, to the first UE 402 may be a TMMBr and/or indicative of a communication bit rate or downlink scheduling associated with the second UE 404. The transmission, at 904, may be performed based on the TMMBr component 199 of the apparatus 1004 in FIG. 10.

At 906, the second UE may receive the TMMBn as an acknowledgment to the indication transmitted to the first UE—the indication corresponds to the TMMBr—the adjusted bit rate for the communication from the first UE is adjusted based on the TMMBn being received as the acknowledgment to the indication transmitted to the first UE. For example, referring to FIG. 4, the second UE 404 may receive, at 411, the TMMBn from the first UE 402, which may be indicative of an adjusted communication bit rate with the first UE 402. The TMMBn received, at 411, from the first UE 402 may be responsive to the indication transmitted, at 408, to the first UE 402 of the decreased network condition at the second UE 404. The reception, at 906, may be performed based on the TMMBr component 199 of the apparatus 1004 in FIG. 10.

At 908, the second UE may receive a request for at least one of BLER information associated with the second UE or grant information associated with the second UE based on the indication transmitted to the first UE of the decreased network condition at the second UE. For example, referring to FIG. 4, the second UE 404 may receive a request/transmit a response, at 414, for BLER and/or grant information associated with the second UE 404. The second UE 404 may receive the request/transmit the response, at 414, for the BLER and/or the grant information based on the indication transmitted, at 408, to the first UE 402 of the decreased network condition at the second UE 404. The reception, at 908, may be performed based on the TMMBr component 199 of the apparatus 1004 in FIG. 10.

At 910, the second UE may receive a communication from the first UE based on an adjusted bit rate associated with the indication transmitted to the first UE of the decreased network condition at the second UE. For example, referring to FIG. 4, the second UE 404 may receive, at 416, a communication from the first UE 402 based on the adjusted bit rate associated with the decreased network condition of the second UE 404 indicated, at 408, to the first UE 402. The reception, at 910, may be performed based on the TMMBr component 199 of the apparatus 1004 in FIG. 10.

At 912, the second UE may transmit one or more subsequent indications of the decreased network condition at the second UE based on one or more requests for the decreased bit rate—the one or more requests for the decreased bit rate are at least one of transmitted to the first UE over a predefined time duration or associated with a reduction of the decreased bit rate to a minimum threshold. For example, referring to FIG. 4, the second UE 404 may transmit, at 418, to the first UE 402 one or more subsequent indications of the decreased network conditions at the second UE 404. The one or more subsequent indications transmitted, at 418, to the first UE 402 may be associated with decreased bit rates over a predefined time duration or the bit rate being reduced to a minimum threshold. The transmission, at 912, may be performed based on the TMMBr component 199 of the apparatus 1004 in FIG. 10.

FIG. 10 is a diagram 1000 illustrating an example of a hardware implementation for an apparatus 1004. The apparatus 1004 may be a UE, a component of a UE, or may implement UE functionality. In some aspects, the apparatus1004 may include a cellular baseband processor 1024 (also referred to as a modem) coupled to one or more transceivers 1022 (e.g., cellular RF transceiver). The cellular baseband processor 1024 may include on-chip memory 1024′. In some aspects, the apparatus 1004 may further include one or more subscriber identity modules (SIM) cards 1020 and an application processor 1006 coupled to a secure digital (SD) card 1008 and a screen 1010. The application processor 1006 may include on-chip memory 1006′. In some aspects, the apparatus 1004 may further include a Bluetooth module 1012, a WLAN module 1014, an SPS module 1016 (e.g., GNSS module), one or more sensor modules 1018 (e.g., barometric pressure sensor/altimeter; motion sensor such as inertial management unit (IMU), gyroscope, and/or accelerometer(s); light and/or radio wave detection devices, light and/or radio wave ranging devices, sound navigation and ranging (SONAR), magnetometer, audio and/or other technologies used for positioning), additional modules of memory 1026, a power supply 1030, and/or a camera 1032. The Bluetooth module 1012, the WLAN module 1014, and the SPS module 1016 may include an on-chip transceiver (TRX) (or in some cases, just a receiver (RX)). The Bluetooth module 1012, the WLAN module 1014, and the SPS module 1016 may include their own dedicated antennas and/or utilize the antennas 1080 for communication. The cellular baseband processor 1024 communicates through the transceiver(s) 1022 via one or more antennas 1080 with the UE 104 and/or with an RU associated with a network entity 1002. The cellular baseband processor 1024 and the application processor 1006 may each include a computer-readable medium/memory 1024′, 1006′, respectively. The additional modules of memory 1026 may also be considered a computer-readable medium/memory. Each computer-readable medium/memory 1024′, 1006′, 1026 may be non-transitory. The cellular baseband processor 1024 and the application processor 1006 are each responsible for general processing, including the execution of software stored on the computer-readable medium/memory. The software, when executed by the cellular baseband processor 1024/application processor 1006, causes the cellular baseband processor 1024/application processor 1006 to perform the various functions described supra. The computer-readable medium/memory may also be used for storing data that is manipulated by the cellular baseband processor 1024/application processor 1006 when executing software. The cellular baseband processor 1024/application processor 1006 may be a component of the UE 350/310 and may include the memory 360 and/or at least one of the TX processor 368, the RX processor 356, and the controller/processor 359. In one configuration, the apparatus 1004 may be a processor chip (modem and/or application) and include just the cellular baseband processor 1024 and/or the application processor 1006, and in another configuration, the apparatus 1004 may be the entire UE (e.g., see 350 of FIG. 3) and include the additional modules of the apparatus 1004.

As discussed supra, the remote UE indication component 198 is configured to receive, from a second UE, a first indication of a decreased network condition at the second UE, the first indication associated with at least one of a TMMBr, a TMMBn, a decreased bit rate, or decreased downlink scheduling; and display, at the first UE, a second indication of the decreased network condition at the second UE based on the first indication received from the second UE. As also discussed supra, the TMMBr component 199 is configured to receive a local indication of a decreased network condition at the second UE; and transmit, to a first UE, an indication of the decreased network condition at the second UE, the indication associated with at least one of a TMMBr, a TMMBn, a decreased bit rate, or decreased downlink scheduling. The remote UE indication component 198 and/or the TMMBr component 199 may be within the cellular baseband processor 1024, the application processor 1006, or both the cellular baseband processor 1024 and the application processor 1006. The remote UE indication component 198 and/or the TMMBr component 199 may be one or more hardware components specifically configured to carry out the stated processes/algorithm, implemented by one or more processors configured to perform the stated processes/algorithm, stored within a computer-readable medium for implementation by one or more processors, or some combination thereof.

As shown, the apparatus 1004 may include a variety of components configured for various functions. In a first configuration, the apparatus 1004, and in particular the cellular baseband processor 1024 and/or the application processor 1006, includes means for receiving, from a second UE, a first indication of a decreased network condition at the second UE, the first indication associated with at least one of a TMMBr, a TMMBn, a decreased bit rate, or decreased downlink scheduling; and means for displaying, at the first UE, a second indication of the decreased network condition at the second UE based on the first indication received from the second UE. The apparatus 1004 further includes means for adjusting a bit rate for a communication with the second UE based on the first indication received from the second UE of the decreased network condition at the second UE. The apparatus 1004 further includes means for transmitting the TMMBn as an acknowledgment to the first indication, wherein the first indication corresponds to the TMMBr, the bit rate for the communication with the second UE being adjusted based on the TMMBn being transmitted as the acknowledgment to the first indication. The apparatus 1004 further includes means for receiving one or more subsequent indications of the decreased network condition at the second UE, the one or more subsequent indications associated with one or more requests for the decreased bit rate, wherein the second indication is displayed at the first UE based on at least one of the one or more subsequent indications being received over a predefined time duration or the decreased bit rate being reduced to a minimum threshold. The apparatus 1004 further includes means for transmitting a request for at least one of BLER information associated with the second UE or grant information associated with the second UE based on the first indication received from the second UE of the decreased network condition at the second UE.

In a second configuration, the apparatus 1004, and in particular the cellular baseband processor 1024 and/or the application processor 1006, includes means for receiving a local indication of a decreased network condition at the second UE; and means for transmitting, to a first UE, an indication of the decreased network condition at the second UE, the indication associated with at least one of a TMMBr, a TMMBn, a decreased bit rate, or decreased downlink scheduling. The apparatus 1004 further includes means for receiving a communication from the first UE based on an adjusted bit rate associated with the indication transmitted to the first UE of the decreased network condition at the second UE. The apparatus 1004 further includes means for receiving the TMMBn as an acknowledgment to the indication transmitted to the first UE, wherein the indication corresponds to the TMMBr, the adjusted bit rate for the communication from the first UE being adjusted based on the TMMBn being received as the acknowledgment to the indication transmitted to the first UE. The apparatus 1004 further includes means for transmitting one or more subsequent indications of the decreased network condition at the second UE based on one or more requests for the decreased bit rate, wherein the one or more requests for the decreased bit rate are at least one of transmitted to the first UE over a predefined time duration or associated with a reduction of the decreased bit rate to a minimum threshold. The apparatus 1004 further includes means for receiving a request for at least one of BLER information associated with the second UE or grant information associated with the second UE based on the indication transmitted to the first UE of the decreased network condition at the second UE.

The means may be the remote UE indication component 198 and/or the TMMBr component 199 of the apparatus 1004 configured to perform the functions recited by the means. As described supra, the apparatus 1004 may include the TX processor 368/316, the RX processor 356/370, and the controller/processor 359/375. As such, in one configuration, the means may be the TX processor 368/316, the RX processor 356/370, and/or the controller/processor 359/375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a first UE, including: receiving, from a second UE, a first indication of a decreased network condition at the second UE, the first indication associated with at least one of a TMMBr, a TMMBn, a decreased bit rate, or decreased downlink scheduling; and displaying, at the first UE, a second indication of the decreased network condition at the second UE based on the first indication received from the second UE.

Aspect 2 may be combined with aspect 1 and further includes adjusting a bit rate for a communication with the second UE based on the first indication received from the second UE of the decreased network condition at the second UE.

Aspect 3 may be combined with any of aspects 1-2 and further includes transmitting the TMMBn as an acknowledgment to the first indication, where the first indication corresponds to the TMMBr, the bit rate for the communication with the second UE being adjusted based on the TMMBn being transmitted as the acknowledgment to the first indication.

Aspect 4 may be combined with any of aspects 1-3 and includes that the second indication displayed at the first UE indicates at least one of the decreased network condition at the second UE, a non-decreased network condition at the first UE, a session condition of the first UE, or the session condition of the second UE.

Aspect 5 may be combined with any of aspects 1-4 and further includes receiving one or more subsequent indications of the decreased network condition at the second UE, the one or more subsequent indications associated with one or more requests for the decreased bit rate, where the second indication is displayed at the first UE based on at least one of the one or more subsequent indications being received over a predefined time duration or the decreased bit rate being reduced to a minimum threshold.

Aspect 6 may be combined with any of aspects 1-5 and includes that the decreased network condition at the second UE corresponds to at least one of increased network congestion or a decreased channel condition associated with the second UE.

Aspect 7 may be combined with any of aspects 1-6 and further includes transmitting a request for at least one of BLER information associated with the second UE or grant information associated with the second UE based on the first indication received from the second UE of the decreased network condition at the second UE.

Aspect 8 may be combined with any of aspects 1-7 and includes that the first indication of the decreased network condition at the second UE corresponds to at least one of in-band signaling from the second UE or an RTP packet indicative of the decreased network condition at the second UE.

Aspect 9 may be combined with any of aspects 1-8 and includes that the at least one of the in-band signaling or the RTP packet is indicative of at least one of an RTP extension header ID, a channel condition, grant information, an RSRP, an RSRQ, an RSSI, or a SINR.

Aspect 10 may be combined with any of aspects 1-9 and includes that a first number of bits associated with the first indication received from the second UE is indicative of the RTP extension header ID and a second number of bits associated with the first indication received from the second UE is indicative of one or more of the channel condition, the grant information, the RSRP, the RSRQ, the RSSI, or the SINR.

Aspect 11 may be combined with any of aspects 1-10 and includes that the second indication is displayed at the first UE based on the first indication corresponding to the RTP packet, the second indication indicating a reason for the decreased network condition at the second UE.

Aspect 12 is a method of wireless communication at a second UE, including: receiving a local indication of a decreased network condition at the second UE; and transmitting, to a first UE, an indication of the decreased network condition at the second UE, the indication associated with at least one of a TMMBr, a TMMBn, a decreased bit rate, or decreased downlink scheduling.

Aspect 13 may be combined with aspect 12 and further includes receiving a communication from the first UE based on an adjusted bit rate associated with the indication transmitted to the first UE of the decreased network condition at the second UE.

Aspect 14 may be combined with any of aspects 12-13 and further includes receiving the TMMBn as an acknowledgment to the indication transmitted to the first UE, where the indication corresponds to the TMMBr, the adjusted bit rate for the communication from the first UE being adjusted based on the TMMBn being received as the acknowlegment to the indication transmitted to the first UE.

Aspect 15 may be combined with any of aspects 12-14 and further includes transmitting one or more subsequent indications of the decreased network condition at the second UE based on one or more requests for the decreased bit rate, where the one or more requests for the decreased bit rate are at least one of transmitted to the first UE over a predefined time duration or associated with a reduction of the decreased bit rate to a minimum threshold.

Aspect 16 may be combined with any of aspects 12-15 and includes that the decreased network condition at the second UE corresponds to at least one of increased network congestion or a decreased channel condition associated with the second UE.

Aspect 17 may be combined with any of aspects 12-16 and further includes receiving a request for at least one of BLER information associated with the second UE or grant information associated with the second UE based on the indication transmitted to the first UE of the decreased network condition at the second UE.

Aspect 18 may be combined with any of aspects 12-17 and includes that the indication of the decreased network condition at the second UE corresponds to at least one of in-band signaling to the first UE or an RTP packet indicative of the decreased network condition at the second UE.

Aspect 19 may be combined with any of aspects 12-18 and includes that the at least one of the in-band signaling or the RTP packet is indicative of at least one of an RTP extension header ID, a channel condition, grant information, an RSRP, an RSRQ, an RSSI, or a SINR.

Aspect 20 may be combined with any of aspects 12-19 and includes that a first number of bits associated with the indication transmitted to the first UE is indicative of the RTP extension header ID and a second number of bits associated with the indication transmitted to the first UE is indicative of one or more of the channel condition, the grant information, the RSRP, the RSRQ, the RSSI, or the SINR.

Aspect 21 is an apparatus for wireless communication for implementing a method as in any of aspects 1-20.

Aspect 22 is an apparatus for wireless communication including means for implementing a method as in any of aspects 1-20.

Aspect 23 may be combined with any of aspects 21-22 and further includes at least one of a transceiver or an antenna coupled to at least one processor of the apparatus.

Aspect 24 is a non-transitory computer-readable medium storing computer executable code, the code when executed by at least one processor causes the at least one processor to implement a method as in any of aspects 1-20.

What is claimed is:

1. An apparatus for wireless communication at a first user equipment (UE), comprising:
a memory; and
at least one processor coupled to the memory and, based at least in part on information stored in the memory, the at least one processor is configured to:
receive, from a second UE, a first indication of a decreased network condition at the second UE, the first indication associated with at least one of a temporary maximum media stream bit rate request (TMMBr), a temporary maximum media stream bit rate notification (TMMBn), a decreased bit rate, or decreased downlink scheduling; and
display, at the first UE, a second indication of the decreased network condition at the second UE based on the first indication received from the second UE.

2. The apparatus of claim 1, wherein the at least one processor is further configured to adjust a bit rate for a communication with the second UE based on the first indication received from the second UE of the decreased network condition at the second UE.

3. The apparatus of claim 2, wherein the at least one processor is further configured to transmit the TMMBn as an acknowledgment to the first indication, wherein the first indication corresponds to the TMMBr, the bit rate for the communication with the second UE being adjusted based on the TMMBn being transmitted as the acknowledgment to the first indication.

4. The apparatus of claim 1, wherein the second indication displayed at the first UE indicates at least one of the decreased network condition at the second UE, a non-decreased network condition at the first UE, a session condition of the first UE, or the session condition of the second UE.

5. The apparatus of claim 1, wherein the at least one processor is further configured to receive one or more subsequent indications of the decreased network condition at the second UE, the one or more subsequent indications associated with one or more requests for the decreased bit rate, wherein the second indication is displayed at the first UE based on at least one of the one or more subsequent indications being received over a predefined time duration or the decreased bit rate being reduced to a minimum threshold.

6. The apparatus of claim 1, wherein the decreased network condition at the second UE corresponds to at least one of increased network congestion or a decreased channel condition associated with the second UE.

7. The apparatus of claim 1, wherein the at least one processor is further configured to transmit a request for at least one of block error rate (BLER) information associated with the second UE or grant information associated with the second UE based on the first indication received from the second UE of the decreased network condition at the second UE.

8. The apparatus of claim 1, wherein the first indication of the decreased network condition at the second UE corresponds to at least one of in-band signaling from the second UE or a real-time transport protocol (RTP) packet indicative of the decreased network condition at the second UE.

9. The apparatus of claim 8, wherein the at least one of the in-band signaling or the RTP packet is indicative of at least one of an RTP extension header identifier (ID), a channel condition, grant information, a reference signal received power (RSRP), a reference signal received quality (RSRQ), a received signal strength indicator (RSSI), or a signal-to-interference-plus-noise ratio (SINR).

10. The apparatus of claim 9, wherein a first number of bits associated with the first indication received from the second UE is indicative of the RTP extension header ID and a second number of bits associated with the first indication received from the second UE is indicative of one or more of the channel condition, the grant information, the RSRP, the RSRQ, the RSSI, or the SINR.

11. The apparatus of claim 8, wherein the second indication is displayed at the first UE based on the first indication corresponding to the RTP packet, the second indication indicating a reason for the decreased network condition at the second UE.

12. The apparatus of claim 1, further comprising at least one of a transceiver or an antenna coupled to the at least one processor.

13. An apparatus for wireless communication at a second user equipment (UE), comprising:
a memory; and
at least one processor coupled to the memory and, based at least in part on information stored in the memory, the at least one processor is configured to:
receive a local indication of a decreased network condition at the second UE; and
transmit, to a first UE, an indication of the decreased network condition at the second UE, the indication associated with at least one of a temporary maximum media stream bit rate request (TMMBr), a temporary maximum media stream bit rate notification (TMMBn), a decreased bit rate, or decreased downlink scheduling.

14. The apparatus of claim 13, wherein the at least one processor is further configured to receive a communication from the first UE based on an adjusted bit rate associated with the indication transmitted to the first UE of the decreased network condition at the second UE.

15. The apparatus of claim 14, wherein the at least one processor is further configured to receive the TMMBn as an acknowledgment to the indication transmitted to the first UE, wherein the indication corresponds to the TMMBr, the adjusted bit rate for the communication from the first UE being adjusted based on the TMMBn being received as the acknowledgement to the indication transmitted to the first UE.

16. The apparatus of claim 13, wherein the at least one processor is further configured to transmit one or more subsequent indications of the decreased network condition at the second UE based on one or more requests for the decreased bit rate, wherein the one or more requests for the decreased bit rate are at least one of transmitted to the first UE over a predefined time duration or associated with a reduction of the decreased bit rate to a minimum threshold.

17. The apparatus of claim 13, wherein the decreased network condition at the second UE corresponds to at least one of increased network congestion or a decreased channel condition associated with the second UE.

18. The apparatus of claim 13, wherein the at least one processor is further configured to receive a request for at least one of block error rate (BLER) information associated with the second UE or grant information associated with the second UE based on the indication transmitted to the first UE of the decreased network condition at the second UE.

19. The apparatus of claim 13, wherein the indication of the decreased network condition at the second UE corresponds to at least one of in-band signaling to the first UE or a real-time transport protocol (RTP) packet indicative of the decreased network condition at the second UE.

20. The apparatus of claim 19, wherein the at least one of the in-band signaling or the RTP packet is indicative of at least one of an RTP extension header identifier (ID), a channel condition, grant information, a reference signal received power (RSRP), a reference signal received quality (RSRQ), a received signal strength indicator (RSSI), or a signal-to-interference-plus-noise ratio (SINR).

21. The apparatus of claim 20, wherein a first number of bits associated with the indication transmitted to the first UE is indicative of the RTP extension header ID and a second number of bits associated with the indication transmitted to the first UE is indicative of one or more of the channel condition, the grant information, the RSRP, the RSRQ, the RSSI, or the SINR.

22. A method of wireless communication at a first user equipment (UE), comprising:
receiving, from a second UE, a first indication of a decreased network condition at the second UE, the first indication associated with at least one of a temporary maximum media stream bit rate request (TMMBr), a temporary maximum media stream bit rate notification (TMMBn), a decreased bit rate, or decreased downlink scheduling; and
displaying, at the first UE, a second indication of the decreased network condition at the second UE based on the first indication received from the second UE.

23. The method of claim 22, further comprising adjusting a bit rate for a communication with the second UE based on the first indication received from the second UE of the decreased network condition at the second UE.

24. The method of claim 23, further comprising transmitting the TMMBn as an acknowledgment to the first indication, wherein the first indication corresponds to the TMMBr, the bit rate for the communication with the second UE being adjusted based on the TMMBn being transmitted as the acknowledgment to the first indication.

25. The method of claim 22, wherein the second indication displayed at the first UE indicates at least one of the decreased network condition at the second UE, a non-decreased network condition at the first UE, a session condition of the first UE, or the session condition of the second UE.

26. The method of claim 22, further comprising receiving one or more subsequent indications of the decreased network condition at the second UE, the one or more subsequent indications associated with one or more requests for the decreased bit rate, wherein the second indication is displayed at the first UE is based on at least one of the one or more subsequent indications being received over a predefined time duration or the decreased bit rate being reduced to a minimum threshold.

27. The method of claim 22, wherein the decreased network condition at the second UE corresponds to at least one of increased network congestion or a decreased channel condition associated with the second UE.

28. The method of claim 22, further comprising transmitting a request for at least one of block error rate (BLER) information associated with the second UE or grant information associated with the second UE based on the first indication received from the second UE of the decreased network condition at the second UE.

29. The method of claim 22, wherein the first indication of the decreased network condition at the second UE corresponds to at least one of in-band signaling from the second UE or a real-time transport protocol (RTP) packet indicative of the decreased network condition at the second UE.

30. A method of wireless communication at a second user equipment (UE), comprising:
receiving a local indication of a decreased network condition at the second UE; and
transmitting, to a first UE, an indication of the decreased network condition at the second UE, the indication associated with at least one of a temporary maximum media stream bit rate request (TMMBr), a temporary maximum media stream bit rate notification (TMMBn), a decreased bit rate, or decreased downlink scheduling.
